(19) United States
(12) Patent Application Publication
(10) Pub. No.: US 2026/0071487 A1
(43) Pub. Date: Mar. 12, 2026

(54) SPRING MOTOR ASSEMBLY FOR AN ARCHITECTURAL-STRUCTURE COVERING

(71) Applicant: HUNTER DOUGLAS INC., NY, NY (US)

(72) Inventors: Toralf H. STRAND, Louisville, CO (US); Max MERRITT, Broomfield, CO (US)

(21) Appl. No.: 19/107,311

(22) PCT Filed: Aug. 21, 2023
(86) PCT No.: PCT/US2023/030671

§ 371 Date: Feb. 27, 2025

Related U.S. Application Data
(60) Provisional application No. 63/403,517, filed on Sep. 2, 2022.

(51) Int. Cl. E06B 9/322

(52) U.S. Cl. CPC E06B 9/322; E06B 2009/3222; E06B 2009/3225

(57) ABSTRACT

A spring motor assembly for use in an architectural-structure covering is disclosed. The spring motor assembly including an output spool, one or more take-up spools, one or more springs coupling the take-up spool(s) to the output spool, cord storage spools for wrapping and unwrapping lift cords thereabout, and capstans (e.g., one-way wheels). In some embodiments, the spring motor assembly includes one or more features to facilitate improved operation. For example, in some embodiments, the capstans include a central longitudinal axis that is angled relative to a central longitudinal axis of the cord storage spools. In addition, in some embodiment, the central longitudinal axis of the cord storage spools, the output spools, and the take-up spool(s) are parallel to a front surface of the covering. In addition, in some embodiments, the spring motor assembly is contained within a unitary housing.

### CROSS-REFERENCE TO RELATED APPLICATIONS

This is a non-provisional of, and claims the benefit of the filing date of, U.S. provisional patent application number 63/403,517, filed Sep. 2, 2022, entitled “Spring Motor Assembly for an Architectural Structure Covering,” the entirety of which application is incorporated by reference herein.

### FIELD OF THE DISCLOSURE

The present disclosure relates generally to the field of architectural-structure coverings, and more particularly to a spring motor assembly for use in an architectural-structure covering (e.g., a manually operated architecture-structure covering such as, for example, a manually operated “cordless” architecture-structure covering).

### BACKGROUND

Architectural-structure coverings may selectively cover an architectural structure such as, for example, a window, a doorway, a skylight, a hallway, an archway, or a portion of a wall (collectively an architectural structure without the intent to limit). Architectural-structure coverings may include a covering that can be extendable and retractable, for example, vertically extendable or retractable (e.g., able to be lowered or raised, respectively, in a vertical direction) relative to a horizontally-oriented headrail between an extended position and a retracted position for obscuring and exposing the underlying architectural structure. The architectural-structure covering may further include a bottom rail attached to a lower edge of the covering.

In some embodiments, the architecture-structure covering may be configured as a “cordless” architectural-structure covering. That is, in some embodiments, the architecture-structure covering is devoid of an operating cord. In use, to move the covering between the extended and retracted positions, some architectural-structure coverings include lift elements such as, for example, lift cords, which extend between the headrail and the bottom rail. In some cases, the lift cords pass through the covering. In use, in some embodiments, the lift cords may be manually-operated. That is, to move the covering between the extended and retracted positions, the user may manually adjust the position of the bottom rail, and hence the covering. For example, to move the covering to the retracted position, the user lifts (e.g., pulls up) on the bottom rail, which causes the bottom rail to move towards the headrail taking up the covering. The lift cords are typically taken-up (e.g., wrapped) about a spool (e.g., a cord storage spool) to secure a relative position of the lift cords so that the covering may be secured at various positions between the extended position and the retracted position. To move the covering to the extended position, the user pulls down on the bottom rail, which causes the bottom rail to move away from the headrail thereby extending the covering. As the covering is extended, the lift cords are released (e.g., unwrapped) from the cord storage spool.

Generally speaking, manually-operated architectural-structure coverings such as, for example, manually-operated “cordless” architectural-structure coverings, include a spring motor assembly, which includes the cord storage spools and which are coupled to the lift cords. In use, the spring motor assembly provides a lifting force to take-up the lift cords and thereby support the weight of the covering.

In use, balancing of the force provided by the spring motor assembly is difficult. For example, when moving the covering to the extended position, the weight of the covering supported by the lift cords decreases and the weight supported by the spring motor assembly decreases. Conversely, when moving the covering to the retracted position, the weight of the bottom rail and the covering supported by the spring motor assembly increases. Unless a spring motor assembly provides a corresponding variable force, a number of problems may occur. For example, if the spring motor assembly does not provide enough lifting force, the covering may not remain in the retracted position and may slowly move downward via the force of gravity. If the spring motor assembly provides too much lifting force, the covering may not remain in the extended position, and the covering may slowly move upwards via the lifting force provided by the spring motor assembly.

In practice, constant force spring motors sized to support the expected full weight of the covering may be used and an external mechanism, such as a clutch, may be used to lock the spring motor when the covering is at the desired location. However, it is desirable to provide a “cordless” architecture-structural covering that is free of exposed operating cords.

Variable force spring motors have also been developed and permit the covering to be extended to virtually any position from fully retracted to fully extended. Still, sizing the spring motor remains difficult.

Another disadvantage of conventional spring motors involves the passing of the lift cords through the spring motor assembly. For example, in some conventional spring motor assemblies, the lift cords travel through the spring motor assembly along a tortuous path in which the lift cords travel through a maze of pins, which creates increased drag, which dampens the action of the spring motor assembly. In addition, the tortuous path tends to increase the force required to lower the covering, while decreasing the available force to lift the covering. In one conventional spring motor design, to reduce the tortuous path and drag issues, the spring motor assembly utilizes capstans (e.g., one-way wheels or spools), which are able to move (e.g., slide) within a slot extending parallel to the lift cords as they exit the assembly. In use, when the lift cords are pulled, the covering lowers with minimal friction. Once the desired position of the covering is achieved, the user stops pulling down on the covering. At this point, the spring force overcomes the downward force applied by the user and the spools move back into their resting position, where they are prevented from rotating backwards due to contact with a chock. When retracting the covering, during lifting of the bottom rail, the spring motor acts on the cord storage spools wrapping the lift cords around the cord storage spools.

However, this design also suffers from numerous disadvantages. For example, during wrapping of the lift cords onto the cord storage spools, the lift cords tend to stack onto themselves and not wrap evenly across the face of the cord storage spool. This phenomenon leads to non-smooth operation, and uneven lift side-to-side. In addition, conventional spring motor assemblies were configured so that the lift cords entered and exited in the same plane, which allows the lift cord to overlap itself and jam.

Additional information on example embodiments of spring motor assemblies can be found in U.S. Pat. No. 6,571,853, issued on Jun. 3, 2003, entitled “Cordless Blind Having Variable Resistance to Movement.”

It is with respect to these and other considerations that the present improvements may be useful.

### SUMMARY

This Summary is provided to introduce a selection of features in a simplified form that are further described below in the Detailed Description. This Summary is not intended to identify key features or essential features of the claimed subject matter, nor is it intended as an aid in determining the scope of the claimed subject matter.

Disclosed herein is an improved spring motor assembly arranged and configured to be used in an architectural-structure covering. The spring motor assembly is arranged and configured to provide a motive force needed to raise a manually operated covering within an architecture-structure covering. In various embodiments, the spring motor assembly includes an output spool, one or more take-up spools, storage spools (e.g., cord storage spools), and one or more capstans (e.g., one-way wheels). In some embodiments, the capstans include a central longitudinal axis that is angled relative to a central longitudinal axis of the cord storage spools.

In some embodiments, the spring motor assembly may also include a geartrain arranged and configured to transmit forces from the output spool to the one or more take-up spools to the cord storage spools. That is, in some embodiments, each of the output spool, the take-up spools, and the cord storage spools may include a gear associated therewith for transmitting forces between the various components. In some embodiments, the geartrain or gears is a set of helical gears.

In some embodiments, the central longitudinal axis of the cord storage spools, the output spool, and the take-up spool(s) are parallel to a front surface of the covering. That is, in some embodiments, the central longitudinal axis of the cord storage spools, the output spool, and the take-up spool(s) extend vertically.

In some embodiments, the spring motor assembly including the output spool, take-up spool(s), cord storage spools, and capstans are positioned within a unitary housing or body. In some embodiments, the spring motor assembly is configured as a flat, pancake style spring motor assembly arranged and configured for mounting onto a top surface of the covering or within the headrail.

In some embodiments, the spring motor assembly includes first and second capstans (e.g., one-way wheels) positioned on either end or side of the spring motor assembly. In use, the capstans include a rotatable hub, which are freely rotatable during extension of the covering (e.g., freely rotatable when the bottom rail of the architectural-structure covering is pulled). Alternatively, in some embodiments, the rotatable hub may be freely rotatable during retraction of the covering (e.g., freely rotatable when the bottom rail of the architectural-structure covering is being lifted).

In some embodiments, the central longitudinal axis of the capstans are angled relative to the central longitudinal axis of the cord storage spools by an angle of between three and seven degrees. Thus arranged, in use, by angling the longitudinal axis of the capstans, improved operation (e.g., wrapping) of the lift cords have been discovered. Turning of the lift cords during wrapping has been minimized, which prevents the lift cords wrapping over themselves during retraction of the covering (e.g., by positioning the capstans at an angle, wrapping of the lift cords is improved, and the lift cords have been found to freely wrap about the cord storage spools and exit the assembly without any issues).

In some embodiments, an architectural-structure covering is disclosed. The architectural-structural covering including a covering movable between a retracted position and an extended position, a spring motor assembly configured to provide a force to raise the covering, and first and second lift cords operatively coupled to the covering and the spring motor assembly. The spring motor assembly including an output spool, one or more take-up spools, first and second cord storage spools, and first and second capstans. Each of the one or more take-up spools includes a spring coupled to the output spool, the spring configured to wrap about the output spool during extension of the covering and unwrap from the output spool during retraction of the covering. The first and second capstans each include a central longitudinal axis that is angled relative to a central longitudinal axis of the first and second cord storage spools.

In some embodiments, the central longitudinal axis of the first and second cord storage spools are parallel to a central longitudinal axis of the output spool and a central longitudinal axis of the one or more take-up spools.

In some embodiments, the central longitudinal axis of the first and second cord storage spools, the central longitudinal axis of the output spool and the central longitudinal axis of the one or more take-up spools are parallel to a front surface of the covering.

In some embodiments, the central longitudinal axis of the first and second capstans are angled relative to the central longitudinal axis of the first and second cord storage spools by an angle of between three and seven degrees.

In some embodiments, the architectural-structure covering further includes a housing, the output spool, the one or more take-up spools, the first and second cord storage spools, and the first and second capstans are positioned within the housing.

In some embodiments, the housing is coupled to a headrail of the architectural-structure covering by a single fastener

In some embodiments, each of the first and second capstans include a rotatable hub, the rotatable hub configured to be freely rotatable during extension of the covering and non-rotatable during retraction of the covering.

In some embodiments, each of the first and second capstans include a rotatable hub, the rotatable hub configured to be freely rotatable during retraction of the covering and non-rotatable during extension of the covering.

In some embodiments, the architectural-structure covering further includes a bottom rail coupled to a lower end of the covering, the first and second lift cords including a lower end associated with one of the covering and the bottom rail and an upper end operatively coupled to the first and second cord storage spools so that during extension and retraction of the covering, the first and second lift cords are selectively wrapped and unwrapped from the first and second cord storage spools.

In some embodiments, the first lift cord passes around the first capstan and is coupled to the second cord storage spool, which is positioned on an opposite end of the spring motor assembly from the first lift cord, and the second lift cord passes around the second capstan and is coupled to the first cord storage spool, which is positioned on an opposite end of the spring motor assembly from the second lift cord.

In some embodiments, the one or more take-up spools includes first and second take-up spools positioned on either side of the output spool, the first and second cord storage spools positioned on either side of the first and second take-up spools, and the first and second capstans positioned on either side of the first and second cord storage spools.

In some embodiments, during extension of the covering, the first and second lift cords unwrap from the first and second cord storage spools, which rotates the first and second cord storage spools, which rotates the first and second take-up spools, which rotates the output spool causing the springs to wrap about the output spool. During retraction of the covering, the spring unwraps from the output spool, which rotates the output spool, which rotates the first and second take-up spools, which rotates the first and second cord storage spools, which wraps the first and second lift cords about the first and second cord storage spools.

In some embodiments, the one or more take-up spools includes a first take-up spool positioned on one side of the output spool, the first cord storage spool positioned on one side of the first take-up spool, the second cord storage spool positioned on one side of the output spool, and the first and second capstans positioned on either side of the first and second cord storage spools.

In some embodiments, the architectural-structure covering further includes a geartrain arranged and configured to transmit forces from the output spool to the one or more take-up spools to the first and second cord storage spools, the geartrain including a plurality of helical gears.

In some embodiments, an architectural-structure covering is disclosed. The architectural-structure covering including a covering movable between a retracted position and an extended position, a spring motor assembly configured to provide a force to raise the covering, and first and second lift cords operatively coupled to the covering and the spring motor assembly. The spring motor assembly includes a housing, an output spool positioned within the housing, one or more take-up spools positioned within the housing, first and second cord storage spools positioned within the housing, and first and second capstans positioned within the housing. Each of the one or more take-up spools including a spring coupled to the output spool, the spring configured to wrap about the output spool during extension of the covering and unwrap from the output spool during retraction of the covering.

In some embodiments, the first and second capstans each include a central longitudinal axis that is angled relative to a central longitudinal axis of the first and second cord storage spools.

In some embodiments, an architectural-structure covering is disclosed. The architectural-structure covering including a covering movable between a retracted position and an extended position, a spring motor assembly configured to provide a force to raise the covering, and first and second lift cords operatively coupled to the covering and the spring motor assembly. The spring motor assembly includes a housing, an output spool, one or more take-up spools, first and second cord storage spools, and first and second capstans. Each of the one or more take-up spools including a spring coupled to the output spool, the spring configured to wrap about the output spool during extension of the covering and unwrap from the output spool during retraction of the covering. The first and second cord storage spools each include a central longitudinal axis that is parallel to a central longitudinal axis of the output spool and a central longitudinal axis of the one or more take-up spools. The central longitudinal axis of the first and second cord storage spools, the central longitudinal axis of the output spool and the central longitudinal axis of the one or more take-up spools are parallel to a front surface of the covering.

In some embodiments, the first and second capstans each include a central longitudinal axis that is angled relative to the central longitudinal axis of the first and second cord storage spools.

### BRIEF DESCRIPTION OF THE DRAWINGS

FIG. 1 is front view illustrating an example embodiment of an architectural-structure covering in accordance with one or more features of the present disclosure;

FIG. 2 is an alternate front view of the architectural-structure covering shown in FIG. 1, FIG. 2 illustrating the architectural-structure covering with the headrail partially removed and the covering transparent to illustrate the spring motor assembly and lift cords;

FIG. 3 is a front, perspective view of an example embodiment of a spring motor assembly in accordance with one or more features of the present disclosure;

FIG. 4 is an alternate front, perspective view illustrating the spring motor assembly shown in FIG. 3, FIG. 4 illustrating the spring motor assembly with part of the housing removed;

FIG. 5 is a rear, perspective view illustrating the spring motor assembly shown in FIG. 3;

FIG. 6 is a perspective view of an alternate embodiment of a spring motor assembly in accordance with one or more features of the present disclosure; and

FIG. 7 is a detailed, partial view of the spring motor assembly shown in FIGS. 3-7.

The drawings are not necessarily to scale. The drawings are merely representations, not intended to portray specific parameters of the disclosure. The drawings are intended to depict example embodiments of the disclosure, and therefore are not be considered as limiting in scope. In the drawings, like numbering represents like elements.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DETAILED DESCRIPTION

Embodiments of a spring motor assembly in accordance with the present disclosure will now be described more fully hereinafter with reference to the accompanying drawings, in which preferred embodiments of the present disclosure are presented. It should be appreciated however that the spring motor assembly of the present disclosure may, however, be embodied in many different forms and should not be construed as being limited to the embodiments set forth herein. Rather, these embodiments are provided so that this disclosure will convey certain features of the spring motor assembly to those skilled in the art.

As will be described in greater detail below, the spring motor assembly of the present disclosure may be used in connection with any suitable architectural-structure covering such as, for example, a manually-operated architectural-structure covering. In use, the spring motor assembly is arranged and configured to provide a motive force used to raise a manually operated covering within an architecture-structure covering. In use, as will be appreciated by one of ordinary skill in the art, the spring motor assembly is arranged and configured to take-up any slack in the lift cords during retraction of the covering. In addition, the spring motor assembly is arranged and configured to prevent any undesired movement of the covering when positioned in its desired position (e.g., prevent, or at least inhibit, unwanted extension and retraction of the covering).

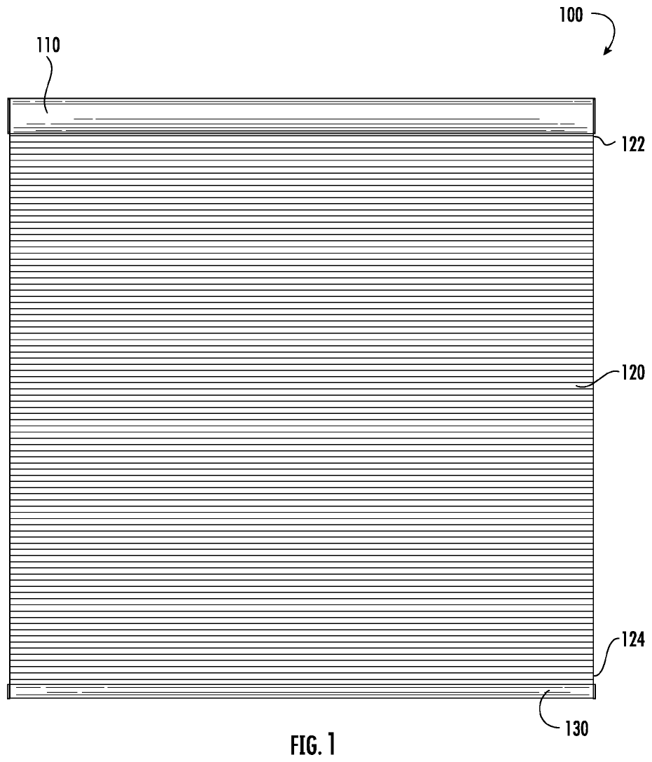

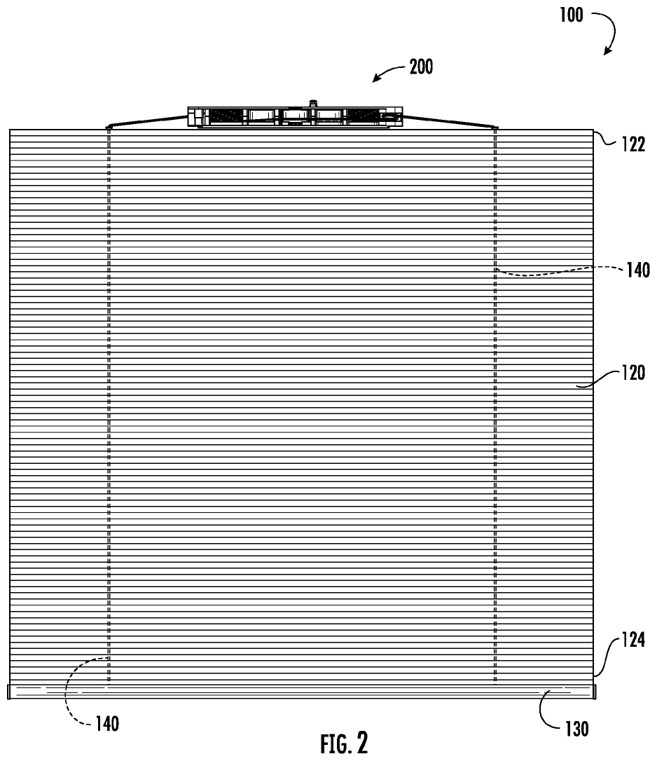

Referring to FIGS. 1 and 2, an example embodiment of an architectural-structure covering 100 is shown. As shown, the architectural-structure covering 100 can include a headrail 110, which in the illustrated embodiment is a housing having opposed end caps joined by front, back, top and bottom sides to form an enclosure. The headrail 110 may include mounts for mounting the architectural-structure covering 100 to a wall or other structure. Although a particular example of a headrail 110 is shown, many different types and styles of headrails exist and could be employed in place of the example headrail illustrated.

In addition, the architectural-structure covering 100 includes a covering 120. In the illustrated example, the covering 120 has an upper edge 122 coupled to the headrail 110 and a lower edge 124 coupled to a bottom rail 130. As will be readily appreciated by one of ordinary skill in the art, the covering 120 of the architectural-structure covering 100 may be suspended from the headrail 110 and may be configured to be vertically extended and retracted relative to the headrail 110 between an extended position (shown in FIGS. 1 and 2), wherein the covering 120 may partially or entirely cover the underlying architectural structure, and a retracted position, wherein the covering 120 may be gathered or stacked adjacent to the headrail 110 in the retracted position.

As illustrated in FIG. 2, and as will be appreciated by one of ordinary skill in the art, the architectural-structure covering 100 may include lift elements such as, for example, lift cords 140, and a spring motor assembly 200. In some embodiments, the spring motor assembly 200 may be positioned within the headrail 110 as illustrated. The spring motor assembly 200 may be coupled to the headrail 110 or top surface of the covering 120, either directly or indirectly, by any suitable mechanism now known or hereafter developed including, for example, fasteners.

In use, as illustrated, the lift cords 140 are operatively coupled to, or associated with, the spring motor assembly 200, as will be described in greater detail below, and coupled to, or associated with, the covering 120 and/or the bottom rail 130. That is, a lower end of the lift cords 140 may be coupled to, or associated with, the covering 120 and/or the bottom rail 130, an upper end of the lift cords 140 may be operatively coupled to, or associated with, the spring motor assembly 200, and an intermediate portion of the lift cords 140 may extend through the covering 120.

In use, to move the covering 120 from the extended position to the retracted position, the user can, for example, manually grip and raise the bottom rail 130 toward the headrail 110. Alternatively, to move the covering 120 from the retracted position to the extended position, the user can manually grip and pull down on the bottom rail 130. During extension of the covering 120, as will be described in greater detail below, the lift cords 140 may be pulled downwardly through gaps in the covering 120, which cause the lift cords 140 to be unwrapped from cord storage spools in the spring motor assembly 200. During retraction of the covering 120, a spring in the spring motor assembly 200 provides a force driving the cord storage spools which may wrap up the lift cords 140.

Although a particular example of an architectural-structure covering 100 is shown in FIGS. 1 and 2, many different types and styles of architectural-structure coverings exist and can be employed in place of the example illustrated in FIGS. 1 and 2. As such, it should be understood that features of the present disclosure may be used in combination with any suitable architectural-structure covering now known or hereafter developed and thus features of the present disclosure should not be limited to any particular type of architectural-structure covering. For example, while a particular covering 120 is illustrated, it should be appreciated that the covering 120 may be manufactured from any suitable material or may have any suitable configuration now known or hereafter developed. For example, as illustrated, in some embodiments, the covering 120 can be made of a fabric material, e.g., a honeycomb structure formed from a fabric material. In alternate embodiments, the covering 120 can also have other types of constructions, e.g., slats, shading rows, etc.

Referring to FIGS. 1 and 2, for the sake of convenience and clarity, all directional references or terms such as, for example, “face,” “front,” “back,” “rear,” “top,” “bottom,” “up,” “down,” “vertical,” “horizontal”, “inner,” “outer”, “proximal,” “distal,” “upper,” “lower,” “upward,” “downward,” “left”, “right,” “lateral,” “longitudinal,” “above,” “below,” “vertical,” “horizontal,” “radial,” “axial,” “clockwise,” and “counterclockwise” are only used for identification purposes to aid the reader's understanding of the present disclosure, and do not create limitations, particularly as to the position, orientation, or use of this disclosure. These references are used herein to describe the relative placement and orientation of various components and portions of the architectural-structure covering 100, each with respect to the geometry and orientation of the architectural-structure covering 100 as they appear in FIGS. 1 and 2. Said reference is intended to be non-limiting and is used herein merely to describe relationship between various components as illustrated in FIGS. 1 and 2.

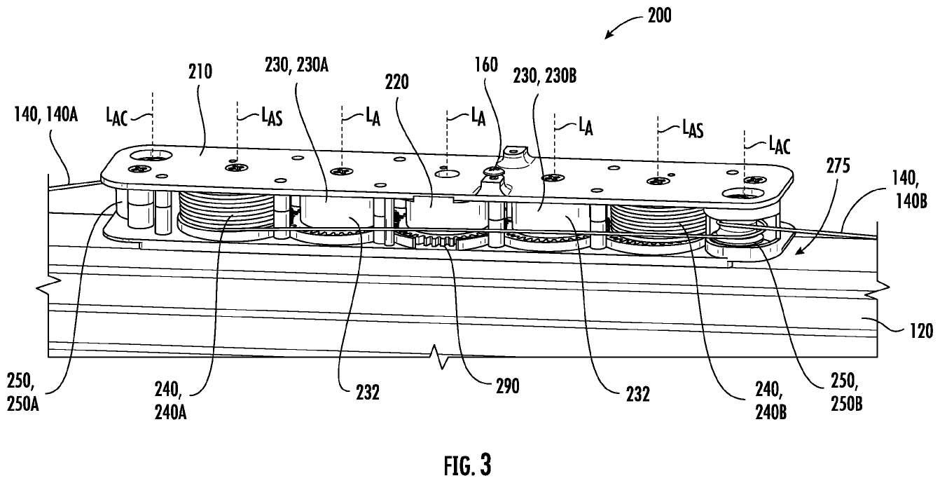

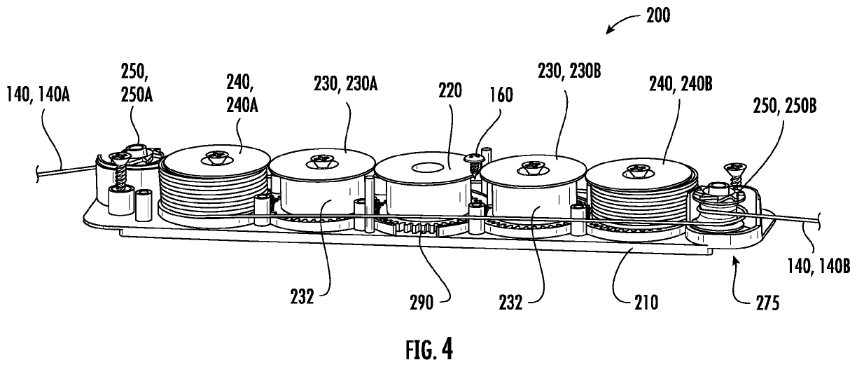

With reference to FIGS. 3-5, in accordance with one or more features of the present disclosure, an example embodiment of a spring motor assembly 200 is disclosed. As illustrated, in some embodiments, the spring motor assembly 200 includes a housing 210, an output spool 220, one or more take-up spools 230 (e.g., first and second take-up spools 230A, 203B) each including a spring 232 for coupling the take-up spool 230 to the output spool 220, cord storage spools 240 (e.g., first and second cord storage spools 240A, 240B), and capstans 250 (e.g., first and second capstans 250A, 250B). In use, as illustrated, the spring motor assembly 200 may also include a geartrain 290 arranged and configured to transmit forces from the output spool 220 via the take-up spools 230, which act like an idler gear, to the cord storage spools 240. That is, as illustrated, each of the output spool 220, the take-up spools 230, and the cord storage spools 240 may include a gear located at a lower end thereof, the gears intermeshing with each other. In use, the geartrain 290 may be a set of spur gears, although this is but one configuration and other suitable gears may be used including, for example, helical gears, which are typically quieter than spur gears. Thus arranged, in accordance with one or more features of the present disclosure, the output spool 220, the take-up spools 230, and the cord storage spools 240 may each include a set of gears (e.g., helical gears, spur gears, or the like) for coupling to each other.

In use, as will be described in greater detail herein, the take-up spools 230 each include a spring 232 for coupling to the output spool 220. In use, movement of the bottom rail 130 from the retracted position to the extended position causes the lift cords 140 (e.g., first and second lift cords 140A, 140B) to extend, which rotates the cord storage spool 240, which rotates the take-up spools 230 and the output spool 220. Rotation of the output spool 220 during extension causes the springs 232 positioned about the take-up spools 230 to unwind from the take-up spools 230 and to wind about the output spool 220. In contrast, when the bottom rail 130 is moved from the extended position to the retracted position, the springs 232 unwinds from the output spool 220 and winds about the take-up spools 230. Rotation of the output spool 220 and the take-up spools 230 rotates the cord storage spools 240, which winds or unwinds the lift cords 140 about the cord storage spools 240 depending on the direction of rotation. As such, each of the take-up spools 230 can be characterized as an idler gear (e.g., spring 232 is not anchored to the take-up spool 230, rather it merely wraps about the take-up spool 230 and is coupled to the output spool 220).

That is, during use, rotation of the first and second cord storage spools 240A, 240B winds and unwinds the first and second lift cords 140A, 140B respectively thereon, and thus raises and lowers the covering 120. Moreover, as will be appreciated by one of ordinary skill in the art, the output spool 220 and the take-up spool(s) 230 are connected by a spring 232 such as, for example, a wrap spring, a coil spring, etc., although any suitable spring may be used. For example, in some embodiments, the spring 232 may be a coil spring in the form of a ribbon of metal pre-stressed on one side to thus cause the spring 232 to have a natural or relaxed state in the form of a wound coil. In use, the spring 232 is wound onto the take-up spool 230. In some embodiments, the spring 232 is wound onto the take-up spool 230 in its relaxed state, and connected to the output spool 220 such that upon rotation of the output spool 220, the spring 232 is back wound onto the output spool 220. Thus, when the output spool 220 rotates and back winds the spring 232 onto the output spool 220, the spring 232 is biased to rewind back onto the take-up spool 230. It is this biasing force which is utilized by the architecture-structure covering 100 to retract the covering 120.

Thus arranged, as will be readily appreciated by one of ordinary skill in the art, the spring motor assembly 200 includes a spring-driven mechanism that can be operable to wind the lift cords 140 when the bottom rail 130 is raised. Once the bottom rail 130 reaches and is released at a desired height, all of the applied forces including the spring force from the spring motor assembly 200, the weight of the covering 120 and the bottom rail 130, and internal friction forces, can be balanced to create an equilibrium condition. As a result, the bottom rail 130 can be held stationary at the desired height.

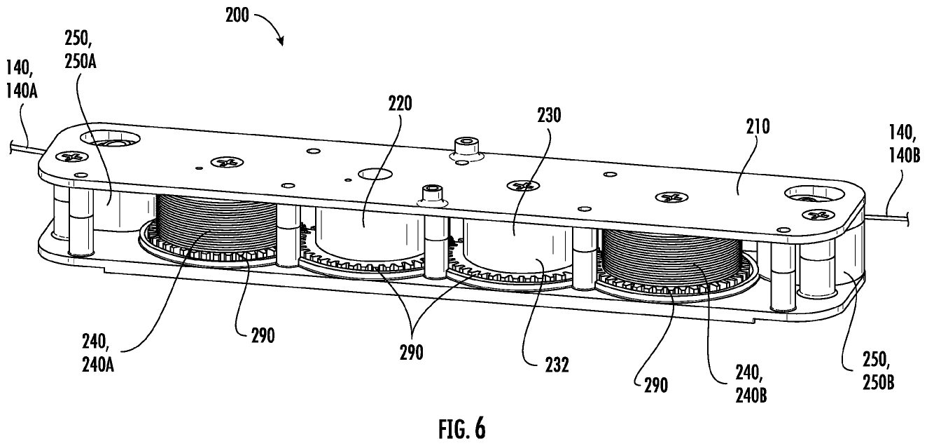

As illustrated, in some embodiments, the output spool 220 is centrally located with the first and second take-up spools 230A, 230B positioned on either side thereof, with the output spool 220 coupled to each of the first and second take-up spools 230A, 230B via a spring 232. It will be appreciated that this is but one embodiment, and in alternate embodiments, a single take-up spool 230 may be utilized with the take-up spool 230 positioned to one side of the output spool 220 (FIG. 6). In either event, the output spool 220 and the take-up spools 230 are positioned between the first and second cord storage spools 240A, 240B. In use, the first and second cord storage spools 240A, 240B are intermeshed via, for example, gears such as, for example, the spur gears or helical gears, as previously described, with the take-up spools 230, which are intermeshed with the output spool 220 (in the embodiment with first and second take-up spools 230A, 230B positioned on either side of the output spool 220) or with the output spool 220 and the take-up spool 230, respectively, (in the embodiment when only a single take-up spool 230 is utilized). In either embodiment, rotation of the cord storage spools 240 causes rotation of the output spool 220 and the take-up spool(s) 230, and thus winding or unwinding motion in the spring 232. In use, as will be appreciated by one of ordinary skill in the art, a spring motor assembly 200 incorporating multiple take-up spools 230 may be used in connection with larger and/or heavier coverings 120. That is, a spring motor assembly 200 incorporating multiple take-up spools 230 may be used in place of a spring motor assembly 200 incorporating a single take-up spool 230 when the covering 120 including the bottom rail 130 is large/heavy enough that the spring force provided by the spring motor assembly 200 incorporating a single take-up spool 230 is unable to overcome the weight of the covering 120 including the bottom rail 130. A spring motor assembly 200 incorporating multiple take-up spools 230 provides a greater spring force as compared to a spring motor assembly 200 incorporating a single take-up spool 230.

For example, when the covering 120 is moved from the retracted position to the extended position, the bottom rail 130 is pulled away from the headrail 110, which pulls the first and second lift cords 140A, 140B away from the headrail 110 (e.g., lift cords 140 are extended, which causes the cord storage spools 240 to rotate). The rotation of the first and second cord storage spools 240A, 240B in turn causes the output spool 220 to rotate and thus back wind the spring 232 from the take-up spool 230 to the output spool 220. The take-up spool 230 is independently mounted such that rotation of the first and second cord storage spools 240A, 240B does not directly cause rotation of the take-up spool 230. Thus, by pulling the bottom rail 130 downwardly away from the headrail 110, the spring 232 is back wound onto the output spool 220 creating a biasing force tending to cause the spring 232 to wind back onto the take-up spool 230, which causes the bottom rail 130 to move towards the headrail 110. By appropriately sizing the width, thickness and/or diameter of the spring 232, this biasing force can be graded such that it is greatest when the bottom rail 130 is fully retracted, and least when the bottom rail 130 is fully extended. Alternatively, if a constant spring force is utilized, a mechanical locking or clamp mechanism can be utilized.

As previously mentioned, the lift cords 140 are wrapped about the cord storage spools 240. In use, as the bottom rail 130, and hence the covering 120, is moved between the extended and retracted position, the lift cords 140 wrap and unwrap about the cord storage spools 240. That is, in use, the first and second lift cords 140A, 140B travel from the spring motor assembly 200 (e.g., first and second cord storage spools 240A, 240B) past the first and second capstans 250A, 250B, through the covering 120, before being coupled to, or associated with, the lower end of the covering 120 and/or the bottom rail 130. Thus, in use, as the bottom rail 130, and hence the covering 120, is moved between the extended and retracted positions, the lift cords 140 are wrapped and unwrapped, respectively, relative to the cord storage spools 240, which causes the cord storage spools 240 to rotate.

In addition, as illustrated, the lift cords 140 travel around (e.g., wrap about) the capstans 250 prior to entering the covering 120. In use, wrapping the lift cords 140 about the capstans 250 assist with smooth transitioning of the lift cords 140 from extending horizontally along a length of the headrail 110 to vertically through the covering 120. Generally speaking, the capstans 250 include a cylindrical hub, which is arranged and configured to rotate to assist with wrapping and unwrapping of the lift cords 140. In use, the first and second capstans 250A, 250B are arranged as one-way wheels positioned on either end or side of the spring motor assembly 200. In use, the capstans 250 are freely rotatable during extension of the covering 120 (e.g., freely rotatable when the bottom rail 130 of the architectural-structure covering 100 is being pulled). For example, in some embodiments, each of the capstans 250 may include a one-way bearing configured to freely rotate in a first direction (clockwise or counterclockwise), but which resists rotation in the opposite direction. By wrapping the lift cords 140 around the capstans 250 and providing the one-way bearing in an orientation which freely rotates with the lift cords 140 when the bottom rail 130 is being pulled from the headrail 110, the capstans 250 resist rotation in the opposite direction. Thus arranged, additional friction is introduced by the one-way bearing when the bottom rail 130 is moved toward the headrail 110. That is, since the capstan 250 does not rotate during retraction, the frictional drag between the lift cords 140 and the capstans 250 slows movement of the lift cords 140 and thus movement of the covering 120.

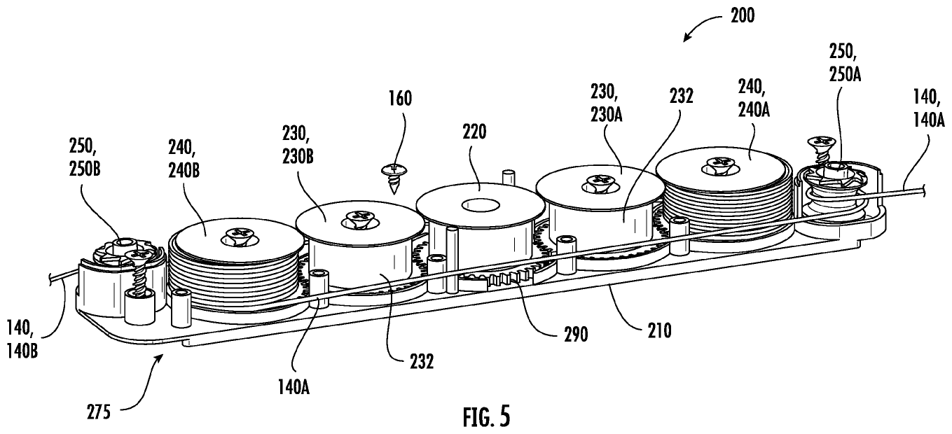

In accordance with one or more features of the present disclosure, as best illustrated in FIG. 5, the first lift cord 140A is coupled to (e.g., wrapped about) the second cord storage spool 240B and the second lift cord 140B is coupled to (e.g., wrapped about) the first cord storage spool 240A. That is, the lift cord 140 associated with the right side of the covering 120 is operatively coupled to the cord storage spool 240 positioned at the left side of the spring motor assembly 200, and vice-versa. As such, the lift cords 140 are operatively coupled to the cord storage spool 240 positioned farther away (e.g., lift cords 140 are coupled to the cord storage spool 240 positioned on the opposite end of the spring motor assembly 200). Thus arranged, the distance between the cord storage spool 240 and the associated capstan 250 is increased, which has been found to provide improved uniform spooling or wrapping (e.g., improved spooling has been found (improved winding of the lift cord 140 onto the cord storage spool 240 to eliminate, or at least minimize, wrapping of the lift cords 140 onto themselves)). However, in alternate embodiments, the first lift cord 140A may be coupled to the first cord storage spool 240A and the second lift cord 140B may be coupled to the second cord storage spool 240B.

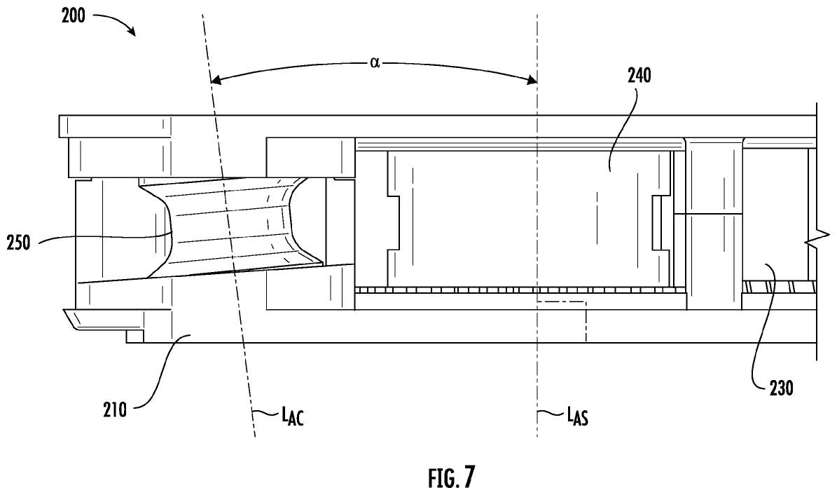

In accordance with one or more features of the present disclosure, each of the first and second capstans 250A, 250B include a central longitudinal axis L_{AC} (FIG. 3). In addition, the first and second cord storage spools 240A, 240B include a central longitudinal axis L_{AS}. In addition, the output spool 220 and the take-up spool(s) 230 include a central longitudinal axis L_{A}. In some embodiments, the central longitudinal axis L_{AC} of the first and second capstans 250A, 250B is angled relative to the central longitudinal axis L_{AS} of the first and second cord storage spools 240A, 240B. That is, the central longitudinal axis L_{AC} of the capstans 250 are angled relative to the central longitudinal axis L_{AS} of the cord storage spools 240. In some embodiments, as illustrated in FIG. 7, the angle a between the central longitudinal axis L_{AC} of the capstans 250 and the central longitudinal axis L_{AS} of the cord storage spools 240 may be between three and seven degrees (e.g., the capstans 250 are mounted at an angle of three-to-seven degrees which keeps the lift cords 140 from forming a riding turn where the lift cords 140 run over themselves). That is, in use, it has been discovered that the lift cords 140 tend to ride over themselves when the capstan is perpendicular to the cord storage spools, which results in the lift cords wrapping over itself if the distance between the capstan and the cord storage spool is not large enough. Thus, by angling the longitudinal axis L_{AC} of the capstans relative to the longitudinal axis L_{AS} of the cord storage spools, the tendency for the lift cords to ride over itself upon retraction or extension of the covering is mitigated. As best illustrated in FIG. 7, in some embodiments, the central longitudinal axis L_{AC} of the capstans 250 is angled outwards by angle a relative to the central longitudinal axis L_{AS} of the cord storage spools 240 (e.g., the central longitudinal axis L_{AC} of the capstans 250 is angled away from the central longitudinal axis L_{AS} of the cord storage spools 240). The central longitudinal axis L_{AC} of the capstans 250 remain in plane with respect to the center of the spring motor assembly 200.

Thus arranged, in accordance with one or more features of the present disclosure, in use, by angling the longitudinal axis L_{AC} of the capstans 250 relative to the longitudinal axis L_{AS} of the cord storage spools 240, the tendency for the lift cords 140 to ride over itself upon retraction or extension of the covering 120 is mitigated. By positioning the longitudinal axis L_{AC} of the capstans 250 at an angle relative to the longitudinal axis L_{AS} of the cord storage spools, the lift cords 140 are free to wrap cleanly and exit the assembly without issues.

In addition, in some embodiments, the central longitudinal axis L_{A} of the output spool 220, the central longitudinal axis L_{A} of the take-up spool 230, and the central longitudinal axis L_{As} of the cord storage spools 240 are all parallel to each other, and thus the central longitudinal axis L_{A} of the output spool 220 and the take-up spool 230 are also angled relative to the central longitudinal axis L_{AC} of the capstans 250.

Moreover, in some embodiments, the central longitudinal axis L_{A} of the output spool 220, the central longitudinal axis L_{A} of the take-up spool 230, and the central longitudinal axis L_{As} of the cord storage spools 240 are all parallel to a front surface of the covering 120. That is, in accordance with one or more features of the present disclosure, the central longitudinal axis L_{A} of the output spool 220, the central longitudinal axis L_{A} of the take-up spool 230, and the central longitudinal axis L_{As} of the cord storage spools 240 extend vertically, which is in contrast to prior art devices where the axes extend horizontally.

In addition, and/or alternatively, in accordance with one or more features of the present disclosure, all of the components of the spring motor assembly 200 including the output spool 220, take-up spools 230, cord storage spools 240, and capstans 250 are positioned within a unitary housing or body 210. Thus arranged, by positioning the central longitudinal axis L_{A} of the output spool 220, the central longitudinal axis L_{A} of the take-up spool 230, and the central longitudinal axis L_{As} of the cord storage spools 240 parallel to the front surface of the covering 120, and by positioning all of the components within a unitary housing 210, the spring motor assembly 200 may be configured as a flat, pancake style spring motor assembly arranged and configured for mounting onto a surface of the headrail 110.

In addition, thus arranged, in some embodiments, the spring motor assembly 200 may be coupled to the headrail 110 utilizing a single fastener 160 thereby facilitating easier assembly. In addition, by utilizing a single screw 160 to couple the spring motor assembly 200 to the headrail 110, some adjustment to move/reposition the spring motor assembly 200 can be introduced.

In use, while a single spring motor assembly has been shown and described in connection with an architectural-structure covering, in some embodiments, multiple spring motor assemblies may be provided. For example, in connection with a Top-Down, Bottom-Up (“TDBU”) architectural-structure covering wherein the top of the covering may be adjusted (e.g., lowered/raised) in addition to adjusting (e.g., lowering/raising) the bottom of the covering, the TDBU architectural-structure covering may include first and second spring motor assemblies for operating with the top rail and the bottom rail, respectively. In such embodiments, in accordance with one or more features of the present disclosure, the housing 210 may include a channel 275 formed in the bottom surface thereof for creating a path for the lift cords from the other spring motor assembling to pass through.

While the present disclosure refers to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

The foregoing description has broad application. It should be appreciated that the features disclosed herein may be used in combination with many types of architectural-structure coverings. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive features may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more embodiments or configurations for the purpose of streamlining the disclosure. However, it should be understood that various features of the embodiments or configurations of the disclosure may be combined in alternate embodiment, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative to sizes reflected in the drawings attached hereto may vary.

1. An architectural-structure covering comprising:
a covering movable between a retracted position and an extended position;
a spring motor assembly configured to provide a force to raise the covering; and
first and second lift cords operatively coupled to the covering and the spring motor assembly;
wherein:
the spring motor assembly includes an output spool, one or more take-up spools, first and second cord storage spools, and first and second capstans;
each of the one or more take-up spools including a spring coupled to the output spool, the spring configured to wrap about the output spool during extension of the covering and unwrap from the output spool during retraction of the covering; and
the first and second capstans each include a central longitudinal axis that is angled relative to a central longitudinal axis of the first and second cord storage spools.

2. The architectural-structure covering of claim 1, wherein the central longitudinal axis of the first and second cord storage spools are parallel to a central longitudinal axis of the output spool and a central longitudinal axis of the one or more take-up spools.

3. The architectural-structure covering of claim 2, wherein the central longitudinal axis of the first and second cord storage spools, the central longitudinal axis of the output spool and the central longitudinal axis of the one or more take-up spools are parallel to a front surface of the covering.

4. The architectural-structure covering of claim 1, wherein the central longitudinal axis of the first and second capstans are angled relative to the central longitudinal axis of the first and second cord storage spools by an angle of between three and seven degrees.

5. The architectural-structure covering of claim 1, further comprising a housing, the output spool, the one or more take-up spools, the first and second cord storage spools, and the first and second capstans are positioned within the housing.

6. The architectural-structure covering of claim 5, wherein the housing is coupled to a headrail of the architectural-structure covering by a single fastener.

7. The architectural-structure covering of claim 1, wherein each of the first and second capstans include a rotatable hub, the rotatable hub configured to be freely rotatable during extension of the covering and non-rotatable during retraction of the covering.

8. The architectural-structure covering of claim 1, wherein each of the first and second capstans include a rotatable hub, the rotatable hub configured to be freely rotatable during retraction of the covering and non-rotatable during extension of the covering.

9. The architectural-structure covering of claim 1, further comprising a bottom rail coupled to a lower end of the covering, the first and second lift cords including a lower end associated with one of the covering and the bottom rail and an upper end operatively coupled to the first and second cord storage spools so that during extension and retraction of the covering, the first and second lift cords are selectively wrapped and unwrapped from the first and second cord storage spools.

10. The architectural-structure covering of claim 9, wherein the first lift cord passes around the first capstan and is coupled to the second cord storage spool, which is positioned on an opposite end of the spring motor assembly from the first lift cord, and the second lift cord 26 passes around the second capstan and is coupled to the first cord storage spool, which is positioned on an opposite end of the spring motor assembly from the second lift cord.

11. The architectural-structure covering of claim 1, wherein the one or more take-up spools includes first and second take-up spools positioned on either side of the output spool, the first and second cord storage spools positioned on either side of the first and second take-up spools, and the first and second capstans positioned on either side of the first and second cord storage spools.

12. The architectural-structure covering of claim 11, wherein:
during extension of the covering, the first and second lift cords unwrap from the first and second cord storage spools, which rotates the first and second cord storage spools, which rotates the first and second take-up spools, which rotates the output spool causing the springs to wrap about the output spool; and
during retraction of the covering, the spring unwraps from the output spool, which rotates the output spool, which rotates the first and second take-up spools, which rotates the first and second cord storage spools, which wraps the first and second lift cords about the first and second cord storage spools.

13. The architectural-structure covering of claim 1, wherein the one or more take-up spools includes a first take-up spool positioned on one side of the output spool, the first cord storage spool positioned on one side of the first take-up spool, the second cord storage spool positioned on one side of the output spool, and the first and second capstans positioned on either side of the first and second cord storage spools.

14. The architectural-structure covering of claim 1, further comprising a geartrain arranged and configured to transmit forces from the output spool to the one or more take-up spools to the first and second cord storage spools, the geartrain including a plurality of helical gears.

15. An architectural-structure covering comprising:
a covering movable between a retracted position and an extended position;
a spring motor assembly configured to provide a force to raise the covering; and
first and second lift cords operatively coupled to the covering and the spring motor assembly;
wherein:
the spring motor assembly includes a housing, an output spool positioned within the housing, one or more take-up spools positioned within the housing, first and second cord storage spools positioned within the housing, and first and second capstans positioned within the housing; and
each of the one or more take-up spools including a spring coupled to the output spool, the spring configured to wrap about the output spool during extension of the covering and unwrap from the output spool during retraction of the covering.

16. The architectural-structure covering of claim 15, wherein the first and second capstans each include a central longitudinal axis that is angled relative to a central longitudinal axis of the first and second cord storage spools.

17. An architectural-structure covering comprising:
a covering movable between a retracted position and an extended position;
a spring motor assembly configured to provide a force to raise the covering; and first and second lift cords operatively coupled to the covering and the spring motor assembly;
wherein:
the spring motor assembly includes a housing, an output spool, one or more take-up spools, first and second cord storage spools, and first and second capstans;
each of the one or more take-up spools including a spring coupled to the output spool, the spring configured to wrap about the output spool during extension of the covering and unwrap from the output spool during retraction of the covering;
the first and second cord storage spools each include a central longitudinal axis that is parallel to a central longitudinal axis of the output spool and a central longitudinal axis of the one or more take-up spools; and
the central longitudinal axis of the first and second cord storage spools, the central longitudinal axis of the output spool and the central longitudinal axis of the one or more take-up spools are parallel to a front surface of the covering.

18. The architectural-structure covering of claim 17, wherein the first and second capstans each include a central longitudinal axis that is angled relative to the central longitudinal axis of the first and second cord storage spools.
